(19) United States
(12) Patent Application Publication
(10) Pub. No.: US 2006/0254103 A1
(43) Pub. Date: Nov. 16, 2006

(54) Modular system for forming a sign blank

(76) Inventors: Leonard K. Strick, Beaufort, SC (US); Jay A. Filby, Walterboro, SC (US)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(21) Appl. No.: 11/128,611

(22) Filed: May 13, 2005

(51) Int. Cl. G09F 7/00

(52) U.S. Cl. 40/605

(57) ABSTRACT

A modular system for forming a sign blank includes a plurality of midpanels preferably formed from resin reinforced with fiberglass. Each of the plurality of midpanels includes a face portion having a sign side and a back side and a key end opposite a channel end. A male key extends beyond the key end at the back side, and a female channel is located at the back side of the face portion, at the channel end such that two of the plurality of midpanels may be joined by interlocking the male key of one such midpanel with the female channel of another such midpanel.

### TECHNICAL FIELD

The present invention generally relates to sign blanks. More particularly, the present invention relates to a modular system for forming a sign blank and a method for forming a sign blank from components of the modular system.

### BACKGROUND OF THE INVENTION

Sign blanks are employed as the supportive backing for signs. Of particular interest are sign blanks that are so large that they must be formed from multiple sign blank panels. Most commonly, these large sign blanks are constructed to be employed as the backing for the large signs employed along or over highways and other roads for identifying the roads, their destinations, upcoming junctions, exits, etc. In the prior art, in order to form a properly sized sign blank to receive a designated sign, sign blanks are formed from multiple aluminum sign blank panels that are bolted, riveted, or otherwise secured to each other through suitable fasteners separate and distinct from the panels themselves. The sign is typically adhered to the surface of the sign blank. Aluminum is typically employed because of its light weight and weather resistance.

Bolting multiple sign panels together is tedious work that requires a good deal of time and labor to align, drill and bolt the panels together, and the art could benefit from new systems that do not require the use of the fasteners of the prior art. If this need is satisfied, sign blank production costs and installation costs may be greatly reduced. Additionally, if sign blanks could be made from other, lighter materials than the typical aluminum employed, the costs for shipping sign blanks and sign blank panels to their end destinations can be reduced as well. Thus, the present invention seeks to provide a modular system for forming a sign blank that does not employ separate fastening elements and in particularly preferred embodiments provides sign blank panels that are not of aluminum construction.

### SUMMARY OF THE INVENTION

In general, this invention provides a modular system for forming a sign blank. This modular system includes a plurality of midpanels. Each of the plurality of midpanels includes a face portion having a sign side and a back side and a key end opposite a channel end. A male key extends beyond the key end at the back side, and a female channel is located at the back side of the face portion, at the channel end such that two of the plurality of midpanels may be joined by interlocking the male key of one such midpanel with the female channel of another such midpanel.

The modular system of this invention is employed in a method for forming a sign blank from modular panels. In accordance with this method, a first modular panel is provided. The first modular panel includes a face portion having a sign side and a back side and a key end opposite a channel end. A male key extends beyond the key end at the back side, and a female channel is located at the back side of the face portion, at the channel end. A second modular panel is also provided. The second modular panel includes a face portion having a sign side and a back side and a key end opposite a channel end. A female channel is located at the back side of the face portion of the second modular panel, at the channel end thereof. Having provided such first and second modular panels, the method for forming a sign blank is achieved by joining the first modular panel to the second modular panel by interlocking the male key of the first modular panel with the female channel of the second modular panel.

The modules of the system and method can be formed of any suitable material and are preferably formed of fiber reinforced plastic, more preferably fiberglass composites.

### BRIEF DESCRIPTION OF THE DRAWINGS

FIG. 1 is a perspective view of a first embodiment of a modular panel in accordance with this invention;

FIG. 2 is a side elevational view thereof;

FIG. 3 is shows the joining of two modular panels in accordance with this invention;

FIG. 4 is a side elevational view of a second embodiment of a modular panel, particularly an end panel;

FIG. 5 is a side elevational view of an end panel of reduced size;

FIG. 6 is a side elevational view of an alternative embodiment of this invention showing a joining like that in FIG. 3; and

FIG. 7 is a side elevational view of a finishing panel according to the invention.

### PREFERRED EMBODIMENT FOR CARRYING OUT THE INVENTION

Referring first to FIGS. 1 and 2, a first embodiment of a modular panel is shown and designated by the numeral 10. Modular panel 10 is one modular panel of the modular system for forming a sign blank in accordance with this invention. Multiple modular panels 10 would be provided and joined together to form as large a sign blank as desired. Other modular panels may be provided, as, for example, the modular panel of FIG. 4. As will be described more fully herein below, the modular panel of FIG. 4 is an end panel that provides a specific profile for beneficial use in the modular system.

Modular panel 10 is preferably formed from resin reinforced plastic, and the shape of modular panel 10, as seen in the figures and described herein, is achieved through a pultrusion method. The figures and the description herein are sufficient for providing those with ordinary skill in the art with enough knowledge for forming the panel through the pultrusion method. Modular panel 10 includes face portion 12 having sign side 14 and back side 16. Face portion 12 is further defined by its perimeter defined at key end 18, channel end 20, and opposed ends 22, 24. Male key 30 extends beyond key end 18 at back side 16. That is, male key 30 does not extend to cross the plane of face portion 12. This allows for a flat profile when two modular panels are joined. Male key 30 takes a shape that is complementary to the shape of female channel 50, which is located at back side 16 of face portion 12, at channel end 20. Due to this configuration, one modular panel 10 is selectively joined to another modular panel 10 by mating male key 30 with female channel 50. This modular aspect is one particular benefit of the present invention. It will be appreciated that the particular shape of male key 30 is not material except for the fact that it should be shaped so that, when it is received in a complementary shaped female channel 50, it may not easily be removed therefrom, particularly in the direction of arrow A. A simple, particularly preferred key shape is provided in accordance with the best mode of this invention, but the invention is not limited thereto or thereby.

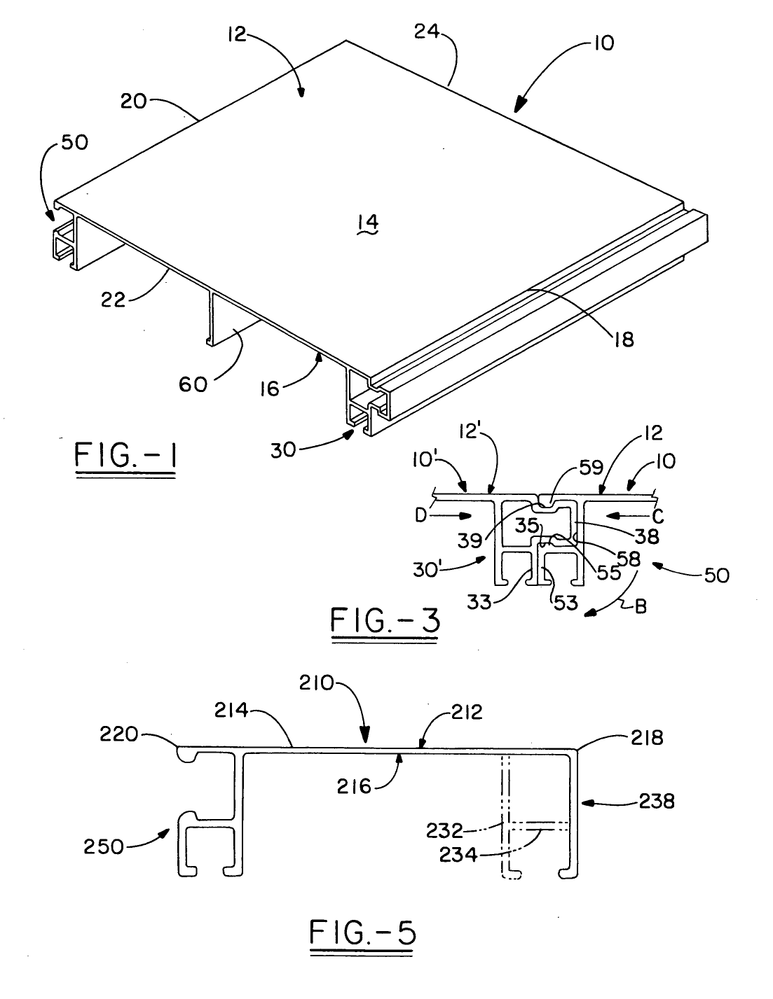

In the embodiment shown, male key 30 extends from key reinforcing rib 32, which extends outwardly from back side 16 of face portion 12, to key end 18. Particularly, extension 34 extends from key reinforcing rib 32 to step 36, which is in registration with key end 18. T-shaped extension 38 extends from step 36, and is joined to key end 18 at step 37. T-shaped extension 38 is the portion of male key 30 that fits within T-shaped receipt 58 of female channel 50. This interconnection can be seen in FIG. 3.

FIG. 3 shows the joining of two modular panels, modular panel 10 and modular panel 10′. Modular panel 10′ is like modular panel 10, particularly at its channel end, shown in FIG. 3. The prime designation is used simply to distinguish it as a separate module. Primes are not used for any of the like parts. As already disclosed, T-shaped extension 38 fits within T-shaped channel 58. It can be seen that ridge 59 is provided at channel end 20 to mate with the notch 39 provided in T-shaped extension 38 and partially defined by step 37. Similarly, tab 55 extends from channel extension 54 to mate with notch 35 provided by T-shaped extension 38 and partially formed by step 36. Channel extension 54, like key extension 34, extends from channel reinforcing rib 52, which is recessed from channel end 20. In this way, the female T-shaped channel 58 is formed from the portion of face portion 12 extending from channel reinforcing rib 52 to channel end 20 and from channel extension 54 extending from channel reinforcing rib 52. Male key 30 further includes stabilizer extension 33, and female channel 50 further includes stabilizer extension 53, which intimately abut one another when T-shaped extension 38 is received in T-shaped channel 58. Because these stabilizer extensions 33, 53 abut one another, they help to keep face portion 12 of modular panel 10 and face portion 12 of modular panel 10′ in one well-defined plane, preventing relative movement between modular panel 10 and modular panel 10′ as, for example, in the direction of arrow B.

As mentioned, modular panels in accordance with this invention, such as modular panels 10, 10′, are preferably formed from resin reinforced plastic, preferably fiberglass reinforced plastic. It will be appreciated that the panels will be lightweight and weather resistant, as are the prior art aluminum sign blank components. Thus, sign blanks prepared from the modular panels of this invention will be just as suitable for the intended uses as the prior art blanks. Additionally, the modular panels of this invention will be easier to assemble, as they will not require the tedious drilling and bolting or riveting, etc., of individual sign blank panels. Rather, the modular panels of this invention will be snapped together by forcing a male key into a female channel, as shown in FIG. 3. The fiberglass and resin composite forming the modular panels gives to pressure, such that it is possible to force two modular panels together by pressing opposed panels in the direction of arrows C and D, as shown in FIG. 3. It is envisioned that an appropriate tool such as an elongated screw clamp might be used for this purpose. The extension of face portion 12 from the recessed channel reinforcing rib 52 as well as channel extension 54 will yield to pressure as opposed panels are pressed together, allowing tabs 55, 59 to slide over T-shaped extension 38 and into notches 35, 39. As an alternative, it is envisioned that a male key, such as male key 30, could be slid into a female channel, such as female channel 50, by sliding lengthwise in the direction perpendicular to arrows C and D (i.e., going into the page in the orientation of FIG. 3).

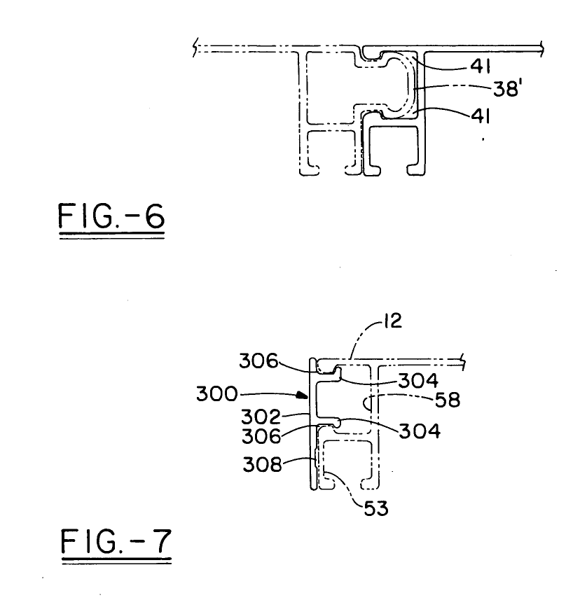

It is contemplated, although not required, that an appropriate adhesive or other bonding agent may be placed on and/or over the surface of T-shaped channel 58 to render the engagement permanent, if desired. In FIG. 6, an alternative embodiment for T-shaped extension 38 is shown as 38′ and has rounded edges to create gaps 41 to receive such adhesive. Less adhesive squeezes out during joinder in such embodiments. Notably, the modules are joined with complete contact along their length as opposed to having effective contact only at bolt/rivet joinders as in the prior art. This provides a stronger end sign blank.

Modular panels in accordance with this invention are preferably from about 6 to about 36 inches in height, from channel end 22 to key end 18. In a particularly preferred embodiments, modules are provided with heights at 6″, 12″, 24″ and 36″. Panel reinforcement rib 60 preferably extends at the midpoint between channel end 20 and key end 18 to lend stability and rigidity to face portion 12.

Referring now to FIG. 4, it can be seen that a modular end panel 110 is optionally provided as part of the modular system. Modular end panel 110 is similar to modular panel 10, and like parts have received like numerals, when appropriate, although increased by 100. End panel 110 differs from modular panel 10 by having a flat end profile 138, as opposed to a male key extension such as T-shaped extension 38. This profile is reinforced with profile reinforcing rib 132, profile extension 134, and provides stabilizer extension 133. Such end panels 110 are preferably provided in both 12 inch and 6 inch heights, from channel end 120 to flat profile end 118. By sizing end panels 100 in this way, sign blank profiles may be created with height dimensions at selective 6 inch intervals.

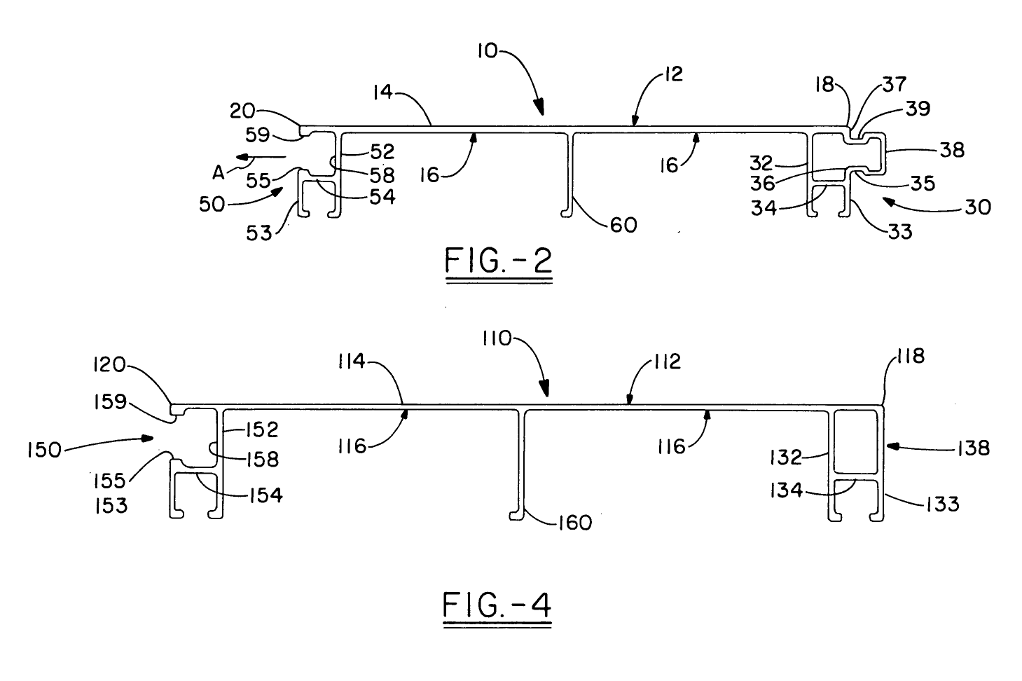

An end panel of smaller dimension is shown in FIG. 5 and designated by the numeral 210. Like parts to modular panel 110 receive like numerals, although increased by 100. End panel 210 differs from end panel 110 by being smaller, and by providing a slightly different, optional flat end profile 238. More particularly, end panel 210 does not include a panel reinforcement rib as does end panel 110, and instead provides flat end profile 238 at the position where rib 160 is on the larger modular panels of the modular system. A reinforcing rib could be included in panel 210 if desired. Additionally, as shown in phantom, profile reinforcing rib 232 and profile extension 234 may be designed into the structure of end panel 210.

A finishing panel is also provided as part of the modular system to close off T-shaped channel 58. This is shown in FIG. 7 as finishing panel 300. Finishing panel 300 includes a cap portion 302 that serves to extend over the opening of the channel 58, preferably from the portion 12 to the bottom of stabilizer extension 53. It is secured by opposed extension 304 that engage the abrupt angled surfaces of the T-shaped channel 58. Gaps 306 are preferably formed between extensions 304 and tabs 55, 59, to receive adhesive. Another gap 308 may be provided between stabilizer extension 53 and cap portion 302 for the same reason.

With a sign blank assembled from the modules as stated above, the sign may be completed by the attachment of a cover sheet upon the aligned face portions 12 of the interconnected modules. Such attachment may be made by adhesive or other appropriate means. The completed sign blank is capable of being retrofit to the same bolt holes on the mounting structure as the prior art aluminum signs.

In light of the foregoing, it should thus be evident that the modular system and process of the present invention substantially improves the art of sign blanks. While, in accordance with the patent statutes, only the preferred embodiments of the present invention have been described in detail hereinabove, the present invention is not to be limited thereto or thereby. Rather, the scope of the invention shall include all modifications and variations that fall within the scope of the attached claims.

What is claimed is:

1. A modular system for forming a sign blank comprising:
a plurality of mid-panels and including:
a face portion having a sign side, a back side, and a key end opposite a channel end,
a male key extending beyond said key end at said back side, and
a female channel located at said back side of said face portion, at said channel end,
wherein two of said plurality of mid-panels may be joined by interlocking said male key of one such mid-panel with said female channel of another such mid-panel.

2. The modular system of claim 1, further comprising a key reinforcing rib extending outwardly from said back side, said male key extending from said key reinforcing rib.

3. The modular system of claim 2, wherein said key reinforcing rib is recessed from said key end, and said male key is formed connecting between said key reinforcing rib and said key end.

4. The modular system of claim 3, further comprising a channel reinforcing rib extending outwardly from said back side, said female channel extending from said channel reinforcing rib.

5. The modular system of claim 4, wherein said channel reinforcing rib is recessed from said channel end, and said female channel is formed from the portion of said face portion extending from said channel reinforcing rib to said channel end and from a channel extension extending from said channel reinforcing rib.

6. The modular system of claim 5, further comprising an channel interlock stabilizer extending outwardly from said channel extension in line with said channel end, and a key interlock stabilizer extending outwardly from said male key in line with said key end, such that, when a male key of one mid-panel is interlocked with a female channel of another mid-panel, said channel interlock stabilizer and said key interlock stabilizer abut one another to maintain the integrity of the interlock.

7. The modular system of claim 6, further comprising a face reinforcing rib extending outwardly from said back side of said face portion at a position approximately equidistant from said first and channel ends of said face portion.

8. The modular system of claim 1, further comprising an end panel including:
a face portion having a sign side and a back side and opposed first and channel ends,
an end rib extending outwardly from said back side of said face portion at said key end, and
a female channel located at said back side of said face portion, at said channel end, wherein an end panel may be joined to a mid panel by interlocking said male key of a mid-panel with said female channel of an end panel, wherein said end rib can not receive a male key and can not interlock with a female channel.

9. A method for forming a sign blank profile from modular panels comprising the steps of:
(a) providing a first modular panel, wherein the first modular panel includes:
a face portion having a sign side and a back side and opposed first and channel ends,
a male key extending beyond said key end at said back side, and
a female channel located at said back side of said face portion, at said channel end,
(b) providing a second modular panel, wherein the second modular panel includes:
a face portion having a sign side and a back side and opposed first and channel ends,
a female channel located at said back side of said face portion, at said channel end; and
(c) joining the first modular panel to the second modular panel by interlocking the male key of the first modular panel with the female channel of the second modular panel.
